(19) United States
(12) Patent Application Publication
(10) Pub. No.: US 2013/0269202 A1
(43) Pub. Date: Oct. 17, 2013

(54) HOUSEHOLD APPLIANCE, IN PARTICULAR LAUNDRY DRYER

(71) Applicant: Miran Razborsek, Velenje (SI)

(72) Inventor: Miran Razborsek, Velenje (SI)

(73) Assignee: Gorenje D.D., Velenje (SI)

(21) Appl. No.: 13/996,062

(22) PCT Filed: Jan. 3, 2012
(86) PCT No.: PCT/IB12/00171

§ 371 Date: Jun. 20, 2013

(30) Foreign Application Priority Data
Jan. 4, 2011 (SI) P-201100007

(51) Int. Cl. F26B 25/16

(52) U.S. Cl. CPC F26B 25/16
USPC 34/130

(57) ABSTRACT

The present invention relates to a household appliance, in particular a laundry dryer comprising a bi-directionally rotating drum to accommodate laundry to be dried, a generator of hot air circulating inside said drum, and a blower to supply said hot air into said drum. It is provided for according to the invention that a channel (12) is attached to a helical casing (21) in which a blower (11) is arranged, said blower (11) supplying an air flow (T3) into a drum (2). A swingable flap gate (22) is formed on the outer perimeter of said helical casing (21) and in the area thereof being close to said blower (11), said flap gate (22) being always pressed against said casing (21) by the gravitational force.

The present invention refers to a household appliance, in particular a laundry dryer comprising a bi-directionally rotating drum to accommodate laundry to be dried, a generator of hot air circulating inside said drum, and a blower to supply said hot air into said drum.

A laundry dryer of the aforementioned kind is well known and, due to the arrangement of the blower in a helical casing in order to efficiently supply air into a drum of the laundry dryer, said blower is optimized for uni-directional rotation only that is in the direction of radial divergence of the casing and the blower. This means that the blower casing is formed in a manner to achieve optimal conditions with regard to the air flow efficiency with the air flow of the constant direction, whereas the air flow efficiency into opposite direction is significantly lower. In the latter case the air impacts the wall of the blower casing resulting in the air turbulence, flow reduction and lower air supply into said drum.

It is the object of the present invention to create a household appliance, in particular laundry dryer which will eliminate drawbacks of the known solutions.

The object as set above is solved by means of the features according to the characterizing portion of the claim 1. It is provided for according to the present invention that a channel is attached to a helical casing in which a blower is arranged, said blower supplying a drying air flow into a drum. A flap gate is formed on the outer perimeter of said helical casing and in the area thereof being close to said blower, said flap gate being constantly pressed against said casing due to the gravitational force.

A household appliance, in particular laundry dryer according to the invention is further described in detail on the basis of the preferred embodiment and with reference to the accompanying drawings, where

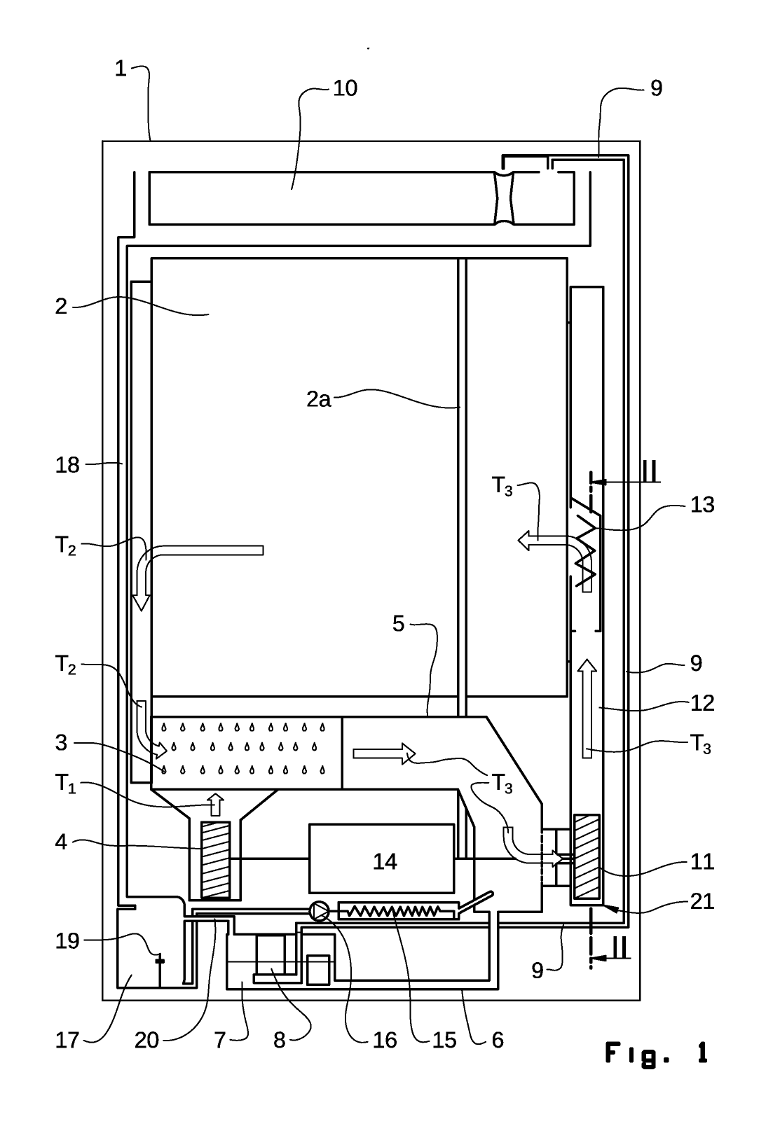

FIG. 1 shows a schematic view of a household appliance, in particular laundry dryer according to the invention,

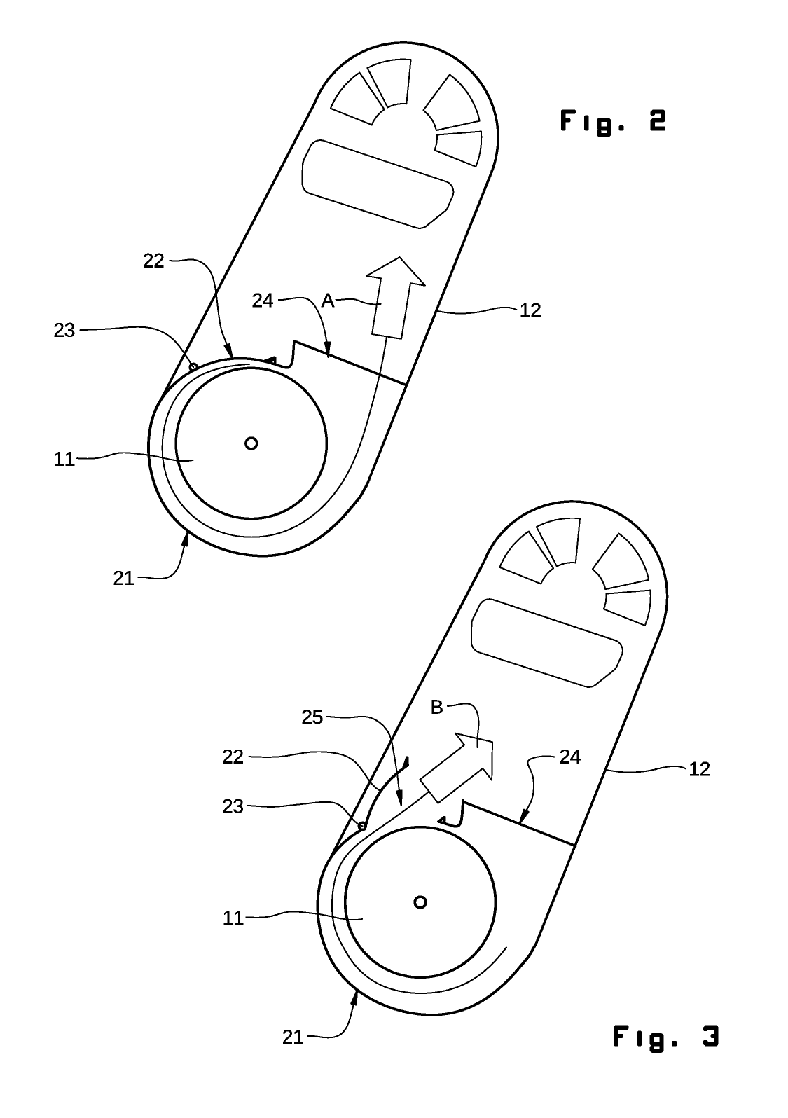

FIG. 2 a cross-sectional view of the household appliance of FIG. 1 along the line II-II with blower rotating into the first direction, and

FIG. 3 a cross-sectional view of the household appliance of FIG. 1 along the line II-II with blower rotating into the second direction.

A household appliance, in particular laundry dryer according to the invention comprises a housing 1 in which a rotating drum 2 is arranged to accommodate laundry to be dried. A condenser 3 is arranged in the area under said drum 2, the first blower 4 being placed below said condenser forcing a flow T₁ of the cooling air through said condenser 3 cooling therewith a flow T₂ of the hot and wet air flowing from said drum 2 and being taken from is the laundry to be dried. A channel 5 is directed from said condenser 3 conducting condensate removed from said flow T₂, said condensate flowing further through a condensate pipeline 6 into a condensate receptacle 7. A pumping means 8 is arranged in said condensate receptacle 7 forcing said condensate through pipeline 9 into a tank 10 above said drum 2. Said pumping means 8 is controlled in a manner known per se by means of electronic controller of the dryer according to the invention.

A second blower 11 is arranged in an extension of said channel 5 forcing an air flow T₃, which comes from the condenser 3, via a channel 12 and through a heater 13 into said drum 2. Said blowers 4, 11 are preferably arranged on the same axis and driven simultaneously by means of a single driving unit 14. In addition, said drum 2 is driven by means of said driving unit 14 utilizing a transmission means 2a, such as a belt for example. Furthermore, a steam generator 15 is arranged in the area below said drum 2, a water preferably a distilled water being fed into said generator 15 by means of a pump 16 which pumps said water from a water container 17 being arranged at the same level in the neighbourhood of the condensate receptacle 7. Said container 17 is fed via a supply line 18 from said water tank 10 above the drum 2. A sensor 19 being arranged in said water container 17 which in case of low water level in said container 17 transmits an appropriate signal to the display of the control panel of the laundry dryer, thus warning the user of the low water level. In such an instance the user himself must add water, preferably distilled water, into said water tank 10 above the drum 2 where from said water overflows via said supply line 18 into said container 17. When said container 17 is completely filled with water the surplus of the water flows via overflow 20 into said receptacle 7.

It is provided for according to the present invention that said channel 12 is associated to a helical casing 21 in which said blower 11 is arranged, said blower 11 forcing into said drum 2 said air flow T₃ supplied from the condenser 3. Said helical casing 21 being associated to said channel 12 in a way that said casing 21 is placed in a leakproof manner entirely inside said channel 12. Said helical casing 21 is formed in the area thereof being close to said blower and on the outer perimeter thereof with a flap gate 22 being capable of rotate preferably about an axis 23 arranged on said casing 21 and parallel with the axis of the driving unit 14. Said rotating axis 23 of said flap gate 22 is placed onto said casing 21 preferably at the side where said blower 11 and said helical casing 21 diverge in radial direction. Furthermore, it is provided for according to the present invention that said flap gate 22 is arranged on said casing 21 on the side and in the manner that it is always pressed against said casing by the gravitational force when the household appliance is non-operating.

When the drum 2 and the blower 11 rotates in the same direction, into direction of divergence of said blower 11 and said casing 21 (cf. arrow A in FIG. 2) in the embodiment shown, said flap gate 22 is pressed due to the gravitational force against said casing 21. Said blower 11 forces said air flow T₃ through a pressure section 24 of said casing 21 and via said channel 12 into said drum 2. However, when the drum 2 and the blower 11 rotates in the direction which is opposite from the first mentioned direction, into direction of merging of said blower 11 and said casing 21 (cf. arrow B in FIG. 3) in the embodiment shown, said flap gate 22 is lifted by said air flow T₃, thus enabling unobstructed air flow via a freed opening 25 into said channel 12 and further into the drum 2. When the drum 2 and the blower 11 rotates again into the first mentioned direction, said flap gate 22 drops due to the gravitational force back on the casing 21, thus closing said opening 25.

The solution according to the present invention substantially increases conditions with the bi-directional rotation of the drum of the laundry dryer, resulting in laundry being dried more consistently. Furthermore, the solution according to the invention enables good energy utilisation of the laundry dryer in spite of the bi-directional rotation of the drum.

The invention has been presented and described on the basis of the embodiment of the laundry dryer with a heat exchanger comprising two blowers being preferably arranged on the same axis and driven simultaneously by means of a single driving unit. However, the invention may be used with different embodiments of the laundry dryer, such as the laundry dryer comprising a heat pump, or with the embodiment comprising more than two blowers, without departing from the spirit and scope of the present invention.

1. A household appliance, in particular laundry dryer comprising: a bi-directionally rotating drum to accommodate laundry to be dried, a generator of hot air circulating inside said drum, and a blower to supply said hot air into said drum, wherein a channel is attached to a helical casing in which said blower is arranged, said blower supplying an air flow into said drum, a swingable flap gate is formed on an outer perimeter of said helical casing and in the area thereof being close to said blower, said flap gate being arranged on said casing on a side and in the manner that it is always pressed against said casing by the gravitational force when the household appliance is non-operating.

2. A household appliance according to claim 1, wherein said helical casing is associated to said channel in a way that said casing is placed in a leakproof manner entirely inside said channel.

3. A household appliance according to claim 1, wherein said flap gate is capable of rotating preferably about an axis arranged on said casing and parallel with an axis of a driving unit.

4. A household appliance according to claim 1, wherein a rotating axis of said flap gate is placed onto said casing preferably at a side where said blower and said helical casing diverge in a radial direction.
